(19) United States
(12) Patent Application Publication
(10) Pub. No.: US 2003/0033841 A1
(43) Pub. Date: Feb. 20, 2003

(54) Bolted door nob

(76) Inventor: Johnny Hilton-Bey, Baltimore, MD (US)

Correspondence Address: Johnny Hilton-Bey, 5628-D Loch Raven Blvd., Baltimore, MD, 21239, US

(21) Appl. No.: 09/850,568

(22) Filed: Aug. 14, 2001

(51) Int. Cl. F16C 3/00

(52) U.S. Cl. 70/224

(57) ABSTRACT

How I came up with this idea, I am having problems in keeping unwanted people out of my apartment, when I am not there. The criminals was prying open the door knob locks and picking the Dead Bolt Locks. I went around to several Hardware Stores and Locksmith Stores around the city. I looked and observed the Dead Bolt Locks and all the door knob locks. I brought so many locks and the problem still is happening. So I wanted to invent something to give the police proof that this problem is happening so they can make a report.

### CROSS-REFERENCE TO RELATED APPLICATION

My application number is Ser. No. 09/850,568. My receipt date is May 5, 2001, which is on the post card sent back to me in the mail.

### STATEMENT REGARDING FEDERALLY SPONSORED RESEARCH OR DEVELOPMENT

Research for getting a Utility Patent was done by Invention Technologies Incorporated for my invention, Bolted Door Nob (knob).

### REFERENCE TO A MICROFICHE APPENDIX

Not Applicable.

### BACKGROUND OF THE INVENTION

The Bolted Door Nob is designed to prevent someone from picking the lock. The lock comes with two keys and there is no master keys that a locksmith can use to enter a place. The only person that have the keys is the owner of the lock. These keys are not allowed to be duplicated. The owner is the only one that can have the keys duplicated. He must have some proof that comes with the lock to prove he is the owner. A picture identification is needed with the proof that comes with the lock to have the keys duplicated.

### BRIEF SUMMARY OF THE INVENTION

The Bolted Door Nob keeps people from prying open the door like they done in the past with screwdrivers, credit cards, and other devices as seen on Television. With this door knob a person do not have to by a steel cover plate to put on the door to keep a person from prying the lock open.

### BRIEF DESCRIPTION OF THE SEVERAL VIEWS OF THE DRAWING

The First device on the drawing page helps keep the door closed. It goes on the opposite side of the stem. The Second device on the drawing page is a Silender (Cylinder), with a Stem. This device goes on the side of the door and the Stem keeps the door closed or locked. The Third devices are door knobs on the drawing page. The inside knob can be open by a turn style device or a key. The outside door knob can only be open by a key. The Forth device on the drawing page are security keys that should not be duplicated without the owner. The Fifth devices are screws and they are use to secure the other devices in place. The Six device is a wrench to tighten the screws in place. The Seven device is the Stem and spring. The spring in the back of the Stem keeps the Stem out to keep the door closed. The door knob must turn a little after it is unlocked to move the Stem inside the Silender (Cylinder) to open the door.

### DETAILED DESCRIPTION OF THE INVENTION

The Bolted Door Nob (knob), can be made just like all other door knobs, except for other thing are added. The Bolted Door Nob has a door knob or handle, and it can keep the door closed without locking it. The lock is tamper free, meaning no Master Keys or picking the lock. The lock have to be cut off or drilled to gain access. If a person loses their key, they can call the police to show them a picture I D. proving they live their. Then they can break the window to get in and get more proof for the police before the police can leave. Once inside they can get their hidden spare key. A window is cheaper to fix than a good door.

### DRAWING

I submitted a possible drawing of a Bolted Door Nob on May 5, 2001.

What I claim as my invention is:

1. The Bolted Door Nob I know there is no Dead Bolt Lock with a door knob or handle attached to it, keeps a door closed without being locked.
